(19) United States
(12) Patent Application Publication
(10) Pub. No.: US 2026/0175443 A1
(43) Pub. Date: Jun. 25, 2026

(54) SUBSTRATE TRANSFER ROBOT AND SUBSTRATE TRANSFER METHOD USING THE SAME

(71) Applicant: Absolics Inc., Covington, GA (US)

(72) Inventors: Chaemook LIM, Covington, GA (US); SUKWAN YOO, Covington, GA (US); MINHO JI, Covington, GA (US); BYUNGJOO PARK, Covington, GA (US); Hyunsik YOON, Covington, GA (US)

(73) Assignee: Absolics Inc., Covington, GA (US)

(21) Appl. No.: 19/430,083

(22) Filed: Dec. 22, 2025

Related U.S. Application Data
(60) Provisional application No. 63/738,527, filed on Dec. 24, 2024.

(51) Int. Cl. B25J 13/08; B25J 9/04

(52) U.S. Cl. CPC B25J 13/08; B25J 9/043

(57) ABSTRACT

The present invention relates to a substrate transfer robot and a substrate transfer method using the same, and the substrate transfer robot according to one aspect of the present invention includes a body, a robot arm formed with a plurality of joints and rotatably installed on the body to transfer a substrate, a first sensor installed on the robot arm to sense a front edge of the substrate to be supported by the robot arm, a second sensor installed on the robot arm to sense a side edge of the substrate supported by the robot arm, and a controller provided on the body and configured to control the operation of the robot arm based on a value sensed by the first sensor and a value sensed by the second sensor.

### CROSS-REFERENCE TO RELATED APPLICATION

This application claims the priority of U.S. Provisional Patent Application No. 63/738,527, filed Dec. 24, 2024, the entire disclosures of which are incorporated herein by reference for all purposes.

### BACKGROUND

### 1. Field

The present invention relates to a substrate transfer robot, which is a technique for transferring a substrate from a loading box or equipment.

### 2. Description of the Related Art

Substrates loaded in a loading box or equipment are transferred one by one by a substrate transfer robot, which is equipped with a robot arm and a hand, and then loaded into each piece of equipment or loading box. In this case, efficiency may be improved by loading the next substrate for processing immediately after unloading the substrate from each piece of equipment using a substrate transfer robot having dual hands.

Meanwhile, in order to grip the substrate with the hand of the substrate transfer robot and stably transfer the substrate, it is necessary, before transferring the substrate, to recognize edges of the substrate, confirm the gripping state of the substrate, and correct the position and posture of the substrate.

In this regard, a substrate transfer robot having a sensor provided in a hand to detect the edges of the substrate is disclosed. This existing technology has the problem that multiple sensors for detection are required along the edges of the substrate for accurate edge detection.

In addition, there is an issue in that the existing sensitivity of the sensor cannot detect a black substrate in which the exposed copper (Cu) surface has turned black by applying a Nova bond or the like during Ajinomoto Build-up Film (ABF) pretreatment.

Specifically, as illustrated in FIG. 6, in the normal case, the edge of a normal substrate 1001 can be detected with the existing sensitivity of the sensor, but the edge of a black substrate 1001A cannot be detected with the existing sensitivity of the sensor, which may result in a sensing error of passing it without detecting it.

Accordingly, when the sensitivity of the sensor is increased, as illustrated in an abnormal case 2 in FIG. 6, when another substrate 2002 positioned above a target substrate 2001 protrudes beyond the target substrate 2001, the sensor may falsely detect an edge of the other substrate 2002 instead of an edge of the target substrate 2001.

This misdetection problem may occur in situations in which the substrate is transferred by dual hands, in which the sensor of the hand that later grips the substrate erroneously. detects the substrate gripped by the hand that first grips the substrate, instead of the substrate currently gripped, thereby causing an error in position and posture correction

### RELATED ART DOCUMENTS

### Patent Documents

Korea Patent Application No. 10-2023-7008332
Korea Patent Application No. 10-2003-0095627

### SUMMARY

In one aspect, a substrate transfer robot capable of accurately determining the gripping state of a substrate with a relatively small number of sensors and correcting the position and posture of the substrate, and a substrate transfer method using the same are provided.

The objects of the present invention are not limited to the above-described objects, and other objects not described above will be clearly understood from the following description by those skilled in the art.

A substrate transfer robot according to one aspect of the present invention includes a body, a robot arm formed with a plurality of joints and rotatably installed on the body to transfer a substrate, a first sensor installed on the robot arm to sense a front edge of the substrate to be supported by the robot arm, a second sensor installed on the robot arm to sense a side edge of the substrate supported by the robot arm, and a controller provided on the body and configured to control the operation of the robot arm based on a value sensed by the first sensor and a value sensed by the second sensor.

A substrate transfer method according to another aspect of the present invention includes allowing one of a pair of robot arms to enter a loading box or equipment, detecting a front edge of the substrate to be supported through a first sensor provided on the robot arm, supporting the substrate through the robot arm, bringing the substrate through the robot arm, detecting a side edge of the substrate supported by the robot arm through a second sensor provided on the robot arm, calculating a left-right deviation based on a joint angle of the robot arm at a time when the side edge is detected, and adjusting a preset loading position according to the left-right deviation.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of a substrate transfer robot according to one embodiment of the present invention;

FIG. 2 is a plan view of a ready position of the substrate transfer robot according to one embodiment of the present invention;

FIG. 3 is a flowchart of a substrate transfer method according to another embodiment of the present invention;

FIG. 4 is a view for describing adjustment of a direction of an end portion of the robot arm through detection of a front edge in embodiments of the present invention;

FIG. 5 is a view for describing detection of a side edge in embodiments of the present invention; and

FIG. 6 is an exemplary view for describing a problem of substrate misdetection according to the sensitivity of a sensor.

### DETAILED DESCRIPTION OF EXEMPLARY EMBODIMENTS

The advantages and features of the present invention and methods for achieving them will become apparent from the following embodiments, which are described in detail with reference to the accompanying drawings. However, the present invention is not limited to the embodiments described below and may be implemented in various other forms. The embodiments are merely provided to fully disclose the present invention and to fully convey the scope of the invention to those skilled in the art, and the present invention is defined only by the claims. Meanwhile, the terms used in the present specification are intended to describe the embodiments, not to limit the present invention. In the present specification, the singular shall include the plural unless the context otherwise requires.

The present invention relates to a substrate transfer robot for unloading and loading a substrate from a loading box and equipment.

In this case, the substrate may be a glass substrate, which may require precise transfer control to prevent breakage.

A technical feature of embodiments of the present invention is that the position and posture of the substrate may be precisely and accurately corrected while using a relatively small number of sensors for detecting the edges of the substrate.

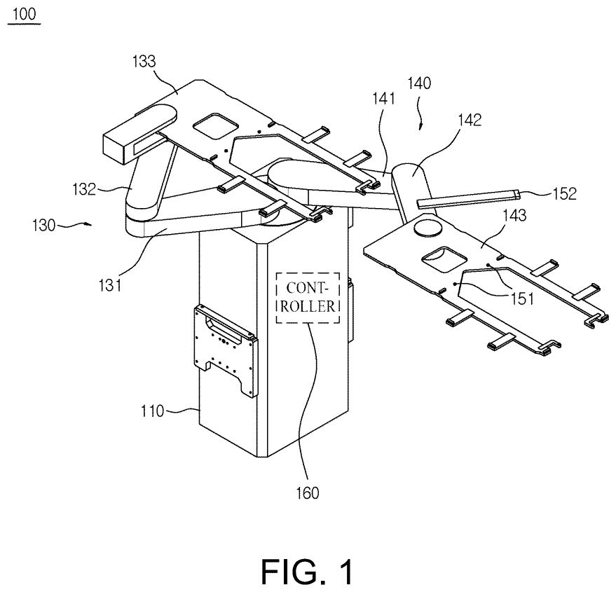

Referring to FIG. 1, the substrate transfer robot 100 according to one embodiment of the present invention may include a body 110, a first robot arm 130, a second robot arm 140, a first sensor 151, a second sensor 152, and a controller 160.

The first robot arm 130 is formed with a plurality of joints and rotatably installed on the body 110 to transfer the substrate.

The first robot arm 130 may include a first link 131, a second link 132, and a first hand 133.

The first link 131 is installed on one side of an upper surface of the body 110 and is rotatable left and right about a rotation axis that is horizontal to a height of the body 110.

The second link 132 is connected to an end portion of the first link 131 and is rotatable left and right.

The first hand 133 is connected to an end portion of the second link 132, and is rotatable left and right to support a lower surface of the substrate.

The second robot arm 140 is formed with a plurality of joints and rotatably installed on the other side of the upper end of the body 110 about a rotation axis that is horizontal to the height of the body 110 to transfer the substrate.

The second robot arm 140 may include a third link 141, a fourth link 142, and a second hand 143.

The third link 141 is installed on the other side of the upper surface of the body 110 and is rotatable left and right about the rotation axis that is horizontal to the height of the body 110.

The fourth link 142 is connected to an end portion of the third link 141 and is rotatable left and right.

The second hand 143 is connected to an end portion of the fourth link 142, and is rotatable left and right to support the lower surface of the substrate.

The first sensor 151 may be installed on the second robot arm 140 to sense a front edge of the substrate to be supported by the second robot arm 140.

The first sensor 151 may include a pair of sensors on the left and right, which are spaced a predetermined interval apart, on an upper surface of the second hand 143 of the second robot arm 140 to sense the front edge of the substrate to be supported by the second hand 143 of the second robot arm 140 when the second hand 143 enters the loading box or equipment.

The second sensor 152 may be installed on the second robot arm 140 to sense a side edge of the substrate supported by the second robot arm 140.

The second sensor 152 may be installed to protrude from a side surface of the fourth link 142 of the second robot arm 140 such that the distance from a side surface of the substrate supported by the second robot arm 140 varies as the second robot arm 140 unfolds and folds, and may sense the side edge of the substrate when the second robot arm 140 supports and brings the substrate.

The second sensor 152 may sense the side edge of the substrate supported by the second hand 143 by increasing the distance from one side of the second hand 143 of the second robot arm 140 as the second robot arm 140 unfolds, and by decreasing the distance from one side of the second hand 143 as the second robot arm 140 folds.

The second sensor 152 may have higher sensitivity than a conventional substrate edge detection sensor to detect the edge of a black substrate, in which the exposed copper (Cu) surface has turned black by applying a Nova bond or the like during Ajinomoto Build-up Film (ABF) pretreatment, positioned on the upper surface of the second hand 143.

The second sensor 152 may have a preset sensitivity that allows detection of a black substrate located at a preset first distance thereabove, but does not allow detection of a substrate (other than a black substrate) located at a preset second distance thereabove that is greater than the first distance.

Accordingly, edge detection may be performed even when the target substrate located thereabove at the first distance from the second hand 143 is a black substrate, while preventing misdetection of an edge of another substrate (other than the target substrate) located above the target substrate.

For convenience of description, the first sensor 151 and the second sensor 152 are illustrated and described based on a state in which the first sensor 151 and the second sensor 152 are installed on the second robot arm 140. However, in embodiments, the first sensor 151 and the second sensor 152 may be installed on the first robot arm 130 and the second robot arm 140, respectively.

The controller 160 may be provided on the body 110 and control the operation of the first robot arm 130 or the second robot arm 140 based on a value sensed by the first sensor 151 and a value sensed by the second sensor 152.

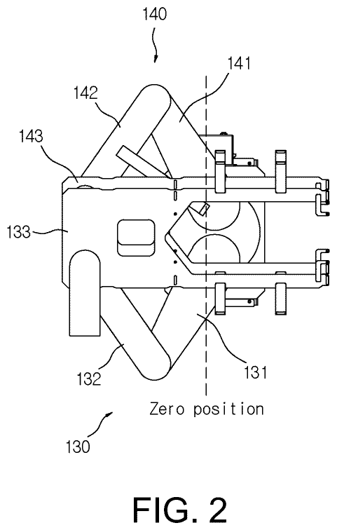

The controller 160 may control the first robot arm 130 and the second robot arm 140 to assume a preset ready position and alternately transfer the substrate from the loading box or equipment, as illustrated in FIG. 2.

The controller 160 may control the first robot arm 130 to unload a substrate from the loading box or equipment, control the second robot arm 140 to unload a substrate from the loading box or equipment, and control the first robot arm 130 and the second robot arm 140 to transfer the substrates respectively supported thereby to preset loading positions when a signal is received from the equipment indicating that loading of the substrate is possible.

That is, substrate transfer efficiency may be improved by transferring the substrates using dual hands.

In addition, the controller 160 may determine the left-right misalignment and left-right deviation of the substrate based on the values sensed by the first sensor 151 and the second sensor 152 when transferring substrates using each of the robot arms 130 and 140, and may transfer the substrates stably by adjusting the direction when supporting the substrate or the position when loading the substrate.

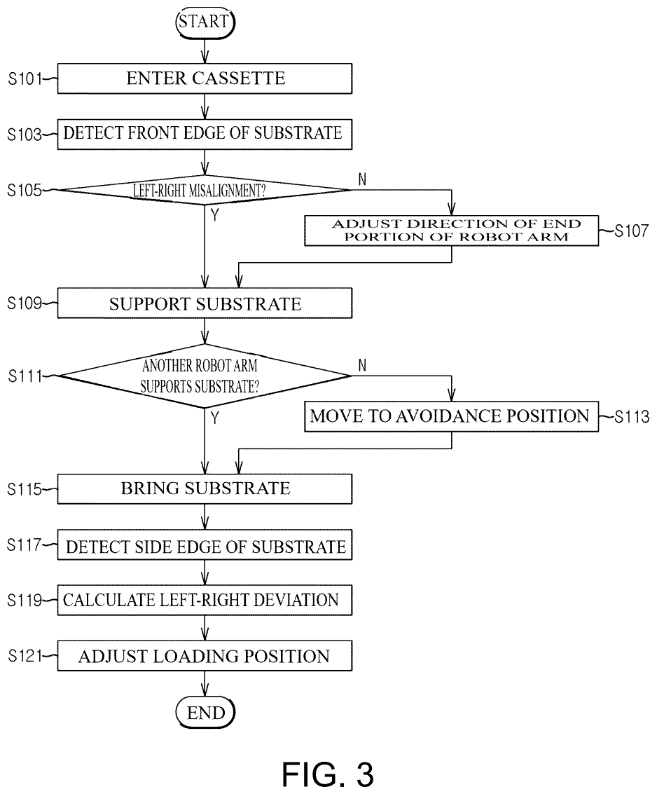

Specifically, referring to FIG. 3, the controller 160 may cause one of the pair of robot arms 130 and 140, that is, the second robot arm 140, to enter the loading box or equipment (S101), and may detect the front edge of the substrate to be supported by the first sensor 151 provided on the second robot arm 140 (S103).

At this time, the controller 160 may detect the front edge of the substrate according to whether at least one of the values sensed by a pair of first sensors 151 exceeds a preset threshold (S103).

Thereafter, the controller 160 may determine left-right misalignment of the substrate based on a difference between the values sensed by the pair of first sensors 151 (S105). When left-right misalignment is determined, the controller 160 may adjust a direction of the end portion of the second robot arm 140 so that the end portion of the second robot arm 140 and the front edge of the substrate are aligned horizontally (S107), and may cause the second robot arm 140 to support the substrate (S109).

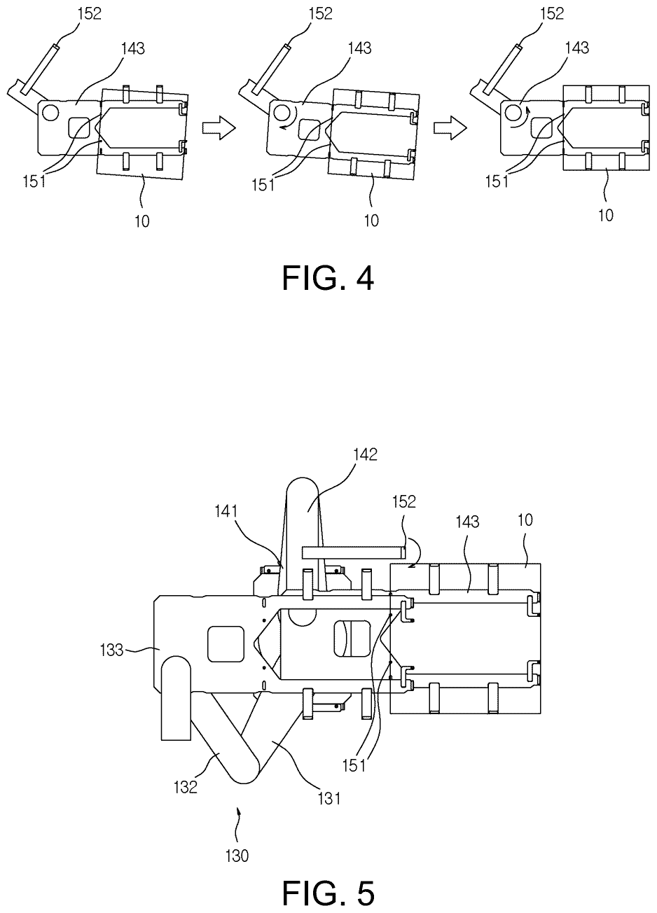

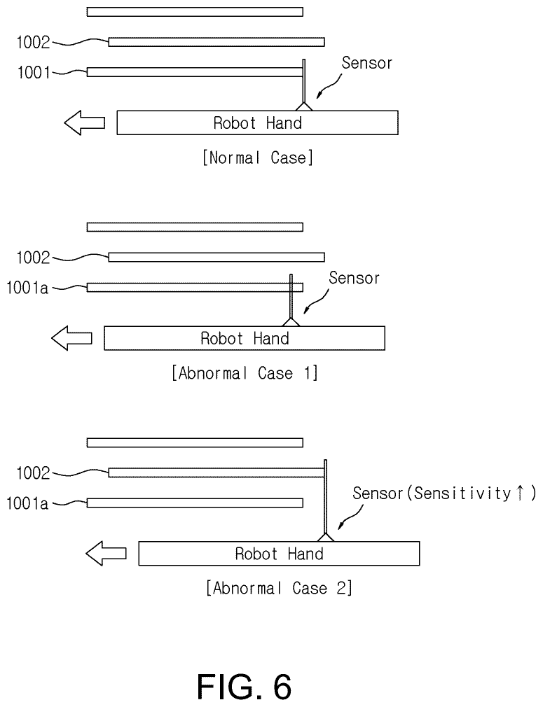

Referring to FIG. 4, the controller 160 may detect the front edge of the substrate 10 by unfolding the second robot arm 140 to enter the loading box or equipment while the second hand 143 of the second robot arm 140 faces a preset direction.

In this case, when the substrate 10 is tilted to the right from the ideal position, the value sensed by the right-side sensor of the pair of first sensors 151 first exceeds the threshold, while the value sensed by the left-side sensor is below the threshold, and the controller 160 determines that left-right misalignment occurs.

Based on the difference between the value sensed by the right-side sensor and the value sensed by the left-side sensor of the pair of first sensors 151, the controller 160 may adjust the direction of the second hand 143 so that the front side of the second hand 143 becomes parallel to the front edge of the substrate 10, thereby supporting the substrate 10 and then returning the direction of the second hand 143 to the preset direction.

When the controller 160 determines that there is no left-right misalignment, the controller 160 may cause the second robot arm 140 to support the substrate directly without adjusting the direction of the end portion of the second robot arm 140 (S109).

In summary, the controller 160 may transfer the substrate while the end portion of the second robot arm 140 faces a preset direction, and when left-right misalignment is determined, may rotate the end portion of the second robot arm 140 to support the substrate, thereby enabling stable loading of the substrate even when the substrate loaded in the loading box or equipment is misaligned left and right.

Thereafter, the controller 160 may determine whether the other of the pair of robot arms 130 and 140, that is, the first robot arm 130, is supporting the substrate (S111), and when it is determined that the first robot arm 130 is supporting the substrate, the controller 160 may move the end portion of the first robot arm 130 to a preset avoidance position (S113).

Here, the avoidance position refers to a position spaced a predetermined distance apart in a direction opposite to the direction in which the substrate is picked up from the ready position.

By moving the end portion of the first robot arm 130 to the preset avoidance position, the controller 160 may prevent the edge of the substrate supported by the first robot arm 130 from entering the sensing range of the second sensor 152 installed on the second robot arm 140 when the second robot arm 140 brings the substrate.

That is, the controller 160 may prevent a misdetection situation caused by increased sensitivity of the second sensor 152 for detecting a black substrate through an avoidance operation.

Subsequently, when the controller 160 determines that the first robot arm 130 is not supporting the substrate, or moves the end portion of the first robot arm 130 to the preset avoidance position, the controller 160 may cause the second robot arm 140 to fold and bring the substrate (S115).

Referring to FIG. 5, the controller 160 may detect the side edge of the substrate 10 based on the value sensed by the second sensor 152 that comes into contact with the side surface of the substrate as the second robot arm 140 folds (S117), and may calculate a left-right deviation based on the joint angle of the second robot arm 140 at the time when the side edge of the substrate is detected (S119).

FIG. 5 illustrates a state in which the substrate 10 is positioned correctly without left-right deviation. However, since only left-right misalignment is corrected when supporting the substrate, the substrate 10 actually supported may be horizontally aligned with the second hand 143 of the second robot arm 140 but may be shifted a certain distance to the left or right.

Since the position and posture of the substrate should be corrected for unloading by combining rotational axis motion and driving axis motion, the left-right deviation is calculated based on the value sensed by the second sensor 152 and used for correction by the driving-side motion.

Specifically, as illustrated in FIG. 5, when the substrate 10 is shifted to the left, the time at which the side edge is detected by the second sensor 152 becomes earlier than when the substrate 10 is in the correct position, and when the substrate 10 is shifted to the right, the time at which the side edge is detected becomes later than when the substrate 10 is in the correct position, and the rotation angles of the joints included in the second robot arm 140 also change accordingly.

The controller 160 may quantify the degree of left-right deviation of the substrate being supported by calculating the left-right deviation based on the joint angle of the second robot arm 140 at the time when the side edge of the substrate is detected.

According to the above configuration, the gripping state of the substrate may be accurately determined without providing a plurality of sensors for detecting the side surfaces of the substrate.

Thereafter, the controller 160 may adjust the preset loading position based on the left-right deviation to transfer and load the substrate (S121).

According to the embodiments of the present invention, the substrate may be stably transferred by supporting the substrate with its misalignment corrected, quantifying the degree of left-right deviation of the substrate being supported based on a value sensed by one sensor, and reflecting the quantified deviation in the loading position of the substrate.

According to the embodiments of the present invention, transfer efficiency may be improved by transferring the substrate in a dual mode through a pair of robot arms. When there is a robot arm that has first gripped the substrate, the misdetection problem caused by increased sensor sensitivity may be avoided by performing an avoidance operation of that robot arm that has grasped the substrate before the other robot arm brings the substrate.

Meanwhile, the operations of the accompanying flowcharts may be implemented as computer instructions loaded into a processor or memory of an electronic device capable of data processing (e.g., a general-purpose computer, a specialized purpose computer, a portable notebook computer, a network computer) to perform the specified functions. Since these computer program instructions may be stored in a computer-readable memory, the functions described in the operations of the block diagram or flowchart may be produced in an article of manufacture including instructional means for performing them.

According to the embodiments of the present invention, there is an effect of being able to correct the position and posture of a substrate by accurately determining a gripping state of the substrate, such as misalignment and left-right deviation of the substrate, with a relatively small number of sensors.

According to the embodiments of the present invention, there is an effect of preventing misdetection when transferring a substrate using dual robot arms.

The effects of the present invention are not limited to the above-described effects, and other effects not described above will be clearly understood from the description of the claims by those skilled in the art.

One having ordinary knowledge in the technical field to which the present invention belongs will be able to understand that the invention may be implemented in other specific forms without altering its technical spirit or essential features. Accordingly, it should be understood that the above-described embodiments are illustrative in all respects and not restrictive. The scope of the present invention is defined by the claims that follow rather than by the foregoing detailed description, and all modifications or variations derived from the equivalents thereof shall be construed as being included within the scope of the present invention.

What is claimed is:

1. A substrate transfer robot comprising:
a body;
a robot arm formed with a plurality of joints and rotatably installed on the body to transfer a substrate;
a first sensor installed on the robot arm to sense a front edge of the substrate to be supported by the robot arm;
a second sensor installed on the robot arm to sense a side edge of the substrate supported by the robot arm; and
a controller provided on the body and configured to control operation of the robot arm based on a value sensed by the first sensor and a value sensed by the second sensor.

2. The substrate transfer robot of claim 1, wherein the first sensor is installed in pairs on the left and right at a predetermined interval on an end portion of the robot arm to sense the front edge of the substrate to be supported when the robot arm enters a loading box or equipment.

3. The substrate transfer robot of claim 2, wherein the controller is configured to:
transfer the substrate by unfolding or folding the robot arm while the end portion of the robot arm faces a preset direction;
determine left-right misalignment of the substrate based on a difference between values sensed by the pair of first sensors when the robot arm enters the loading box or equipment; and
when the left-right misalignment is determined, adjust a direction in which the end portion of the robot arm faces so that a front side of the end portion of the robot arm becomes horizontal with a front side of the substrate, and support the substrate.

4. The substrate transfer robot of claim 1, wherein the second sensor is installed to protrude from a side surface of the robot arm such that a distance from a side surface of the substrate supported by the robot arm varies according to unfolding and folding operations of the robot arm, and senses the side edge of the substrate when the robot arm supports and brings the substrate.

5. The substrate transfer robot of claim 2, wherein the controller calculates a left-right deviation according to a joint angle of the robot arm at a point in time when the value sensed by the second sensor satisfies a preset reference while the robot arm supports and brings the substrate, and
adjusts a preset loading position according to the left-right deviation.

6. The substrate transfer robot of claim 1, wherein a pair of robot arms are provided, and
the controller controls a first robot arm and a second robot arm, which are the pair of robot arms, to alternately transfer the substrate, and when the first robot arm supports the substrate while the second robot arm is supporting the substrate, moves an end portion of the second robot arm to a preset avoidance position and then causes the first robot arm to bring the substrate.

7. A substrate transfer method performed by a controller that controls operation of a pair of robot arms configured to transfer a substrate, the method comprising:
allowing one of the pair of robot arms to enter a loading box or equipment;
detecting a front edge of the substrate to be supported through a first sensor provided on the robot arm;
supporting the substrate through the robot arm;
bringing the substrate through the robot arm;
detecting a side edge of the substrate supported by the robot arm through a second sensor provided on the robot arm;
calculating a left-right deviation based on a joint angle of the robot arm at a time when the side edge is detected; and
adjusting a preset loading position according to the left-right deviation.

8. The substrate transfer method of claim 7, wherein the first sensor is installed in pairs on the left and right at a predetermined interval on the robot arm, and
the detecting of the front edge includes detecting the front edge of the substrate according to whether at least one of values sensed by the pair of first sensors exceeds a preset threshold.

9. The substrate transfer method of claim 8, further comprising: after the detecting of the front edge and before the supporting of the substrate through the robot arm,
determining left-right misalignment of the substrate based on a difference between the values sensed by the pair of first sensors; and
adjusting a direction of an end portion of the robot arm so that the end portion of the robot arm and the front edge of the substrate are horizontal.

10. The substrate transfer method of claim 7, further comprising: after the supporting of the substrate through the robot arm and before the bringing of the substrate through the robot arm,
determining whether the other robot arm of the pair of robot arms is supporting the substrate; and
moving an end portion of the other robot arm to a preset avoidance position when it is determined that the other robot arm is supporting the substrate.
